(19) United States
(12) Patent Application Publication
(10) Pub. No.: US 2004/0258143 A1
(43) Pub. Date: Dec. 23, 2004

(54) Transceiver with upper level communication status indicator and method of troubleshooting

(75) Inventors: Kenneth Roger Jones, Cool, CA (US); Brian Gonsalves, Antioch, CA (US)

Correspondence Address: TOLER & LARSON & ABEL L.L.P., 5000 PLAZA ON THE LAKE STE 265, AUSTIN, TX, 78746, US

(73) Assignee: SBC, Inc.

(21) Appl. No.: 10/601,078

(22) Filed: Jun. 20, 2003

(51) Int. Cl. H04B 1/38

(52) U.S. Cl. 375/222

(57) ABSTRACT

An access provider technician can inquire, from a remote location, a status of an upper-layer communication indicator. For example, a technician, after receiving a trouble call from an end-user, can ask the end-user the visual status of the upper-layer communication indicator. Next, the technician can enter the status into data storage, for example, an electronic job ticket. A first set of actions is performed if the status indicates valid communication. A second set of actions is performed if the status indicates invalid communication. The upper-layer communication indicator indicates a high layer communication status, for example, layer 3 of the OSI model, such as a Point-to-Point Protocol over Ethernet (PPPoE) authentication status.

### BACKGROUND

1. Field of the Invention

The present disclosure relates to digital subscriber line (DSL) systems, and more particularly, to techniques for implementation and maintenance of DSL systems.

2. Description of the Related Art

Determining the cause of technical problems in consumer digital subscriber line (DSL) service has been a challenging obstacle in DSL deployments. Problems can vary from noise on the line, improper customer premise equipment (CPE) set up, network problems, and the like. Even after initial deployment, intermittent outages occur for many providers.

DSL is a distance-sensitive technology. As the DSL line connection's length increases, the signal quality decreases and the connection speed goes down. The limit for DSL service is about 18,000 feet (5,460 meters), though for speed and quality of service reasons many access providers place a lower limit on the permitted distances for the service.

Additionally, DSL implementation is complex due to multiple protocols used in the transfer of packets between end-user computer and a source or destination site. Any improper setup or connection can cause communication to completely fail. Even if all protocols are properly configured and communication is occurring, a particular DSL implementation may not function properly due to authentication problems, for example, incorrect user identifiers or passwords.

The configuration of DSL transceivers is often complex. Client software is installed on end-user computers. The access provider is often responsible to maintain transceivers and the client software. When problems arise, trouble shooting typically involves the access provider sending a technician to a customer premise, which can be very costly and time consuming. Additionally, the access provider typically maintains a database of usernames and passwords for subscribers.

Visual indicators, such as light emitting diodes (LED) are provided on many DSL transceivers. However, these LEDs provide only minimal trouble shooting capability because they only indicate low-level connection status. Accordingly, there is a need for an improved method and system for troubleshooting Digital Subscriber Line (DSL) connections to save the time and expense of dispatching an access provider technician to an end-user's premise.

### BRIEF DESCRIPTION OF THE DRAWINGS

FIG. 1 illustrates an exemplary DSL implementation that includes a transceiver providing an upper level communication status indicator.

FIG. 2 illustrates the International Standards Organization (ISO) model of a data communications system referred to as the Open Systems Interconnection (OSI) model.

FIG. 3 relates the OSI model to a DSL implementation utilizing Point-to-Point Protocol over Ethernet (PPPoE).

FIG. 4. illustrates a flow diagram for trouble-shooting a DSL connection according to an embodiment of the present invention.

FIG. 5 illustrates a view of a transceiver having an upper level communication status indicator according to an embodiment of the present invention.

The use of the same reference symbols in different drawings indicates similar or identical items.

### DESCRIPTION OF THE DRAWINGS

According to a particular embodiment of the present invention, an access provider technician can inquire, from a remote location, a status of an upper-layer communication indicator. For example, a technician, after receiving a trouble call from an end-user, can ask the end-user the visual status of the upper-layer communication indicator. Next, the technician can enter the status into data storage, for example, an electronic job ticket. A first set of actions is performed if the status indicates valid upper-layer communication. A second set of actions is performed if the status indicates invalid upper-layer communication.

In another embodiment, a transceiver is provided. The transceiver includes a connection port configured to communicate data signals from a computer to a service provider device and a first status indicator configured to indicate at least a layer 3 or above communication status between the computer and the service provider device.

According to a particular embodiment, a high level visual indicator is disposed on a DSL transceiver to provide layer 3 and above communication status, for example, an authentication status, such as Point-to-Point Protocol over Ethernet (PPPOE) authentication status.

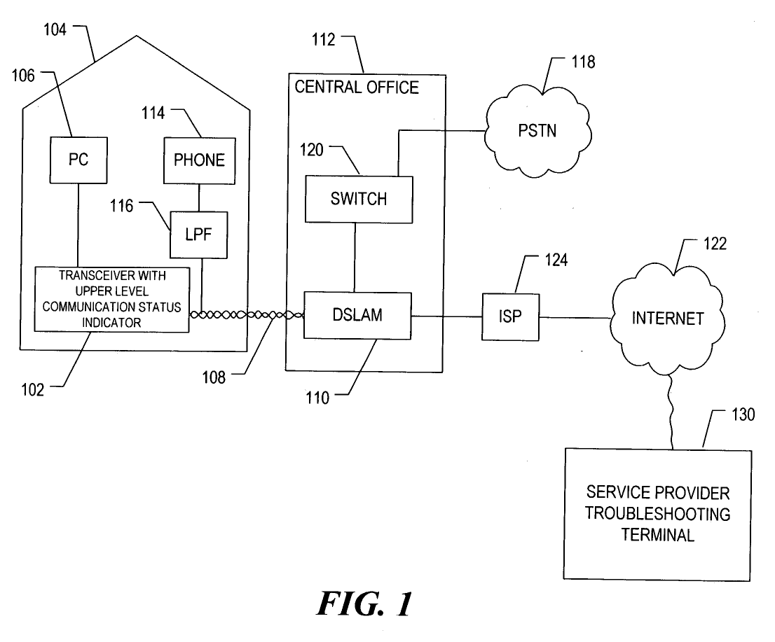

FIG. 1 illustrates an exemplary Digital Subscriber Line (DSL) implementation 100. DSL provides high-speed Internet access using existing telephone lines. A transceiver that includes and upper level communication status indicator 102 or other customer premise equipment (CPE) with such an indicator is located at a customer premise 104, for example, a home or business, and sends and receives data signals between one or more end-user's computers 106 through, for example, an Ethernet connection. Transceiver 102 sends and receives the data signals through twisted pair (copper) wires 108 or other communications medium such as fiber, wireless, and the like between a DSL Access Multiplexer (DSLAM) 10 at an access provider's premise at a central office 112. Twisted pair wires 108 also send and receive voice signals from one DSL line. Transceiver 102 can connect to a customer's equipment in several ways, though most residential installations use a universal serial bus (USB) or 10 base-T Ethernet connections. The transceivers used by businesses may combine network routers, network switches, or other networking equipment in the same platform.

DSLAM 110 at access provider 112 can connect to many customers and aggregate them onto a single, high-capacity connection to Internet 122. DSLAMs are generally flexible and able to support multiple types of DSL in a single central office and different varieties of protocol and modulation in the same type of DSL. In addition, DSLAM 110 may provide additional functions including routing or dynamic IP address assignment.

DSL is sometimes referred to as xDSL because there are many variations of the DSL protocol. The xDSL “family tree” includes two main branches, symmetric and asymmetric. Symmetric DSL services provide identical data rates upstream and downstream; asymmetric DSL provides relatively lower rates upstream but higher rates downstream. Many typical uses of the Internet, such as file downloads and general web browsing, benefit from greater downstream bandwidth but require relatively little bandwidth in the upstream direction. A service provider technician may respond to end user trouble requests. The service provider technician may use a service terminal 130 coupled to the Internet 122 to communicate with and troubleshoot the DSL connection 108. The terminal 140 may include data storage and may be implemented as a personal computer or as a special purpose terminal device.

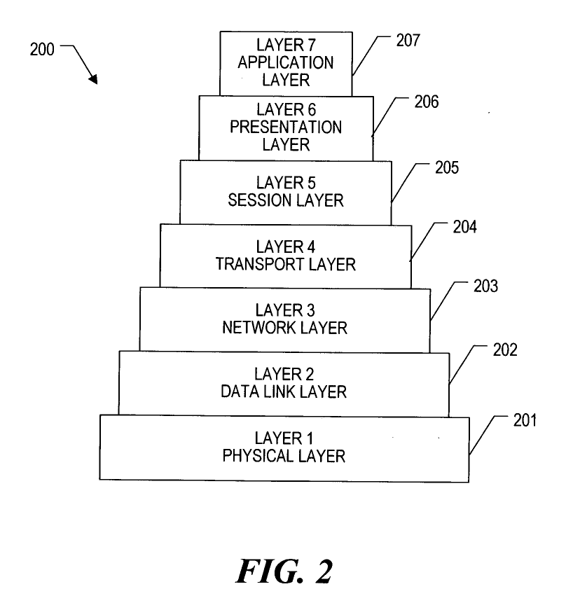

FIG. 2 illustrates the International Standards Organization (ISO) standard model of a data communications system referred to as Open Systems Interconnection (OSI) model 200. OSI model 200, consisting of seven layers, describes a data-communication protocol when one computer communicates with another. OSI model 200 was designed to facilitate creating a system in which equipment from different vendors can communicate. The higher the layer in the OSI model 200, the more meaningful the communication is to the end-user.

Layer 1, a physical layer 201, provides for the transmission of a stream of data over physical cables and wires. Hardware and software operating at this level deal with the types of connectors, signaling, and media-sharing schemes used on the network. Physical layer 201 furnishes electrical connections and signaling. Subsequent layers communicate over the physical layer 201. Twisted-pair wiring, fiber-optic strands, and coaxial cable are all part of physical layer 201.

Layer 2, a data-link layer 202, provides for the reliable transfer of information across physical layer 201. Data-link layer 202 synchronizes the blocks of data, recognizes errors, and controls the flow of data. Once the physical and electrical connections are established, the data stream between the end-user and the device at the other end is controlled. Data-link layer 202 strings characters together into messages and checks messages before transmission over physical layer 201. Data-link layer 202 may also receive an “arrived safely” message from the receiving device's data-link layer. Data-link layer 202 uses many protocols, including high-level data link control (HDLC), bisynchronous communications, and advanced data communications control procedures (ADCCP). In computer-based communications systems, special integrated circuits on interface cards typically perform the functions of data-link layer 202.

Layer 3, a network layer 203, provides an interface between physical layer 201 and data-link layer 202 and the higher-level software, which establishes and maintains connections. Larger wide area networks typically offer a number of ways to move a string of characters (put together by data-link layer 202) from one geographic point to another. Network layer 203 decides which physical pathway the data should take, based on network conditions, priority of service, and other factors. Software that implements network layer 203 usually resides in switches in the network. Many networks use the Internet Protocol (IP) and follow the details of the IP to address, route, and handle packages of data.

Software at Layer 4, a transport layer 204, provides for reliable and transparent transfer of packets between stations. Transport layer 204 performs many of the same functions as network layer 203, but transport layer 204 performs such functions locally. Drivers in the networking software perform transport layer 204 tasks. If the network goes down, software at transport layer 204 looks for alternative routes and resends the packet of transmitted data until successful or a preset time limit is reached. Transport layer 204 handles quality control by verifying that the data received is in the right format and in the right order. This formatting and ordering capability is useful when the transport layer 204 is used to implement connections among dissimilar computers. Networks of dissimilar computers can use several transport layer protocols, such as the transmission control protocol (TCP). One or more pieces of transport layer 204 software reside in each network station and pass calls between application programs on the network.

Layer 5, a session layer 205, provides a standard method of moving data between application programs. Session layer 205 performs the functions that enable two applications (or two pieces of the same application) to communicate across the network in order to perform security, name recognition, login, administration, and other similar functions.

Layer 6, a presentation layer 206, formats data for viewing and for use on specific equipment. Presentation layer 206 might also handle encryption and some special file formatting. Presentation layer 206 formats screens and files so that the final product is displayed as instructed by the programmer. Hypertext Transfer Protocol (HTTP), which is often used to format the information contained on Web sites, is an example of a presentation layer 206 protocol. Presentation layer 206 software also controls printers, plotters, and other peripherals.

Software at Layer 7, an application layer 207, follows standards for look and feel. The top of the layer model, application layer 207 includes the network operating system and application programs, performing everything from file sharing, print-job spooling, and electronic mail to database management and accounting. The user controls this layer directly.

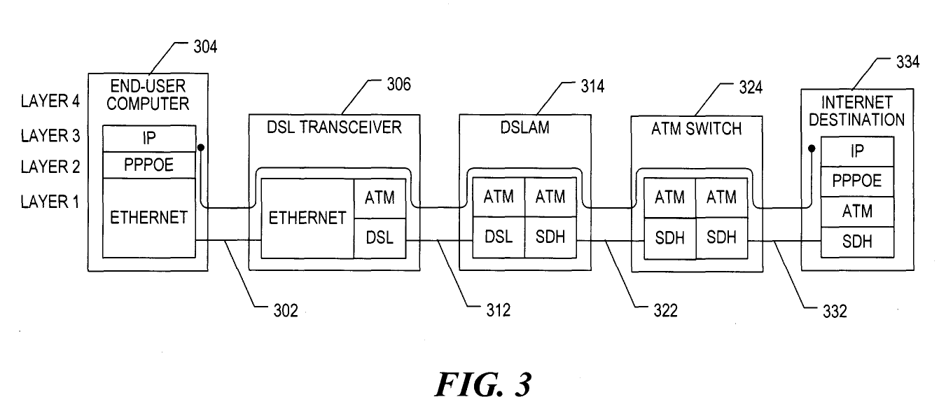

FIG. 3 relates OSI model 200 to a DSL implementation utilizing Point-to-Point Protocol over Ethernet (PPPoE). PPPoE is a protocol typically used by DSL access providers to manage Internet Protocol (IP) addresses and to authenticate users. PPPoE provides for a point-to-point connection to be established over a logical connection between two unique MAC-addresses on an Ethernet network. Once the PPPoE layer discovers the end-points to be used in the link and negotiates a connection, frames can be sent to and received from the PPPoE layerjust as if the link was a serial line. PPPoE is documented in Request For Comments (RFC) 2516 published by the Internet Society.

An IP router such as a DSL router joins a home local area network (LAN) to the wide-area network (WAN) of the Internet. When an end-user accesses the Internet through a DSL implementation, multiple layers of communication are used. Referring to FIG. 3, physical layer, layer 1, connections include Ethernet connection 302 between end-user computer 304 and DSL transceiver 306, DSL connection 312 between DSL transceiver 306 and DSLAM 314, Synchronous Digital Hierarchy (SDH) connection 322 between DSLAM 314 and Asynchronous Transfer Mode (ATM) switch 324 and SDH connection 332 between ATM switch 324, and Internet destination 334. Using physical layer connections, each of end-user computer 304, DSL transceiver 306, DSLAM 314, ATM switch 324 and Internet destination 334 communicate with each other at a basic communication level.

Additionally, devices communicate to each other according to higher-level protocols. For example, end-user computer 304 and Internet site 334 communicate together as follows: First, an application on end-user computer 304 sends data down through the OSI layers from layer 7 to layer 1, which is the sent through an Ethernet connection to the DSL Router. The Router has a layer 1/2/3 connection up and running from itself to the BRAS. The router puts up a PPPoE connection from Layer 2, and when a PC or other device sends data to the router, it works as a relay agent to sent/receive data over the DSL/PPPoE link (e.g. PC→Router→DSLAM→ATM→BRAS→Internet).

A packet request from an IP layer or higher layer is made to the PPPoE layer. The PPPoE layer calls the TCP/IP stack and puts a wrapper around the TCP/IP packet received from the stack. An additional modification can occur to make the packet look like an Ethernet frame expected by DSL transceiver 306. DSL transceiver 306 converts the Ethernet frame to a serial packet for DSL transport. At the service provider, DSLAM 314 converts the DSL serialized Ethernet frame into a switched packet frame such as an ATM frame for transport to the ISP, for example ATM switch 324. Other protocols can be used, for example, frame-relay and the like. ATM switch 324 then performs specified modifications to the packet, such as swapping the IP address, and forwards the packet to the router that forwards the modified packet to Internet destination 334.

As illustrated, Ethernet protocol straddles both layers 1 and 2 because the protocol defines the physical connection 302 (Ethernet cabling, pinout and the like) as well as the packets and frames sent over physical connection 302. In a particular embodiment, the PPPoE executes at layer 2 on a hardware device, such as a router.

To provide a point-to-point connection over Ethernet, each PPP session learns the Ethernet address of the remote peer, as well as establishes a unique session identifier. PPPoE includes a discovery protocol that provides this learning function.

PPPoE has two distinct stages. There is a discovery stage and a PPP session stage (described above). When a host desires to initiate a PPPoE session, the host first performs discovery to identify the Ethernet MAC address of the peer and establishes a PPPoE SESSION_ID. While PPP defines a peer-to-peer relationship, discovery is inherently a client-server relationship. In the discovery process, a host (end-user computer 304) discovers an access concentrator. The PPPoE Server may be implemented as the BRAS (BroadBand Remote Access Server). The DSLAM aggregates user connections (combines say 450 DSL connections from different phone lines to 1 line). ATM provides transport from Central Office to BRAS location since the DSLAM and BRAS are typically many miles apart. The BRAS (PPPoE Server) performs authentication. After authentication, a user is connected to a GSR or 75xx backbone router, which is then put on the Internet backbone.

Based on the network topology, there may be more than one access concentrator that the host can communicate with. The discovery stage allows the host to discover several available access concentrators and then selects one. When discovery completes successfully, both the host and the selected access concentrator have the information they will use to build their point-to-point connection over Ethernet.

The discovery stage remains stateless until a PPP session is established. Once a PPP session is established, both the host and the access concentrator allocate the resources for a PPP virtual interface.

When the discovery stage is completed, both peers know the PPPoE SESSION_ID and the peer's Ethernet address, which together define the PPPoE session uniquely. The discovery stage includes the host broadcasting an initiation packet, one or more access concentrators sending offer packets, the host sending a unicast session request packet and the selected access concentrator sending a confirmation packet. When the host receives the confirmation packet, it may proceed to the PPP session stage. When the access concentrator sends the confirmation packet, the access concentrator may proceed to the PPP session stage.

To trouble-shoot a DSL connection, the layer at which the connection is failing should be determined. Low-level connections are often easy to detect due to visual indicators on a CPE transceiver. However, in prior art systems, higher-level communications are often terminated internally to the transceiver, without indicating to the end-user if the communications were successful or not. In such systems, to determine communication status may require opening a web browser on a connect computer, logging in to the transceiver, and viewing information on communication status, for example, PPPoE authentication, via a graphical user interface (GUI). These extra steps require end-user involvement and increase troubleshooting costs.

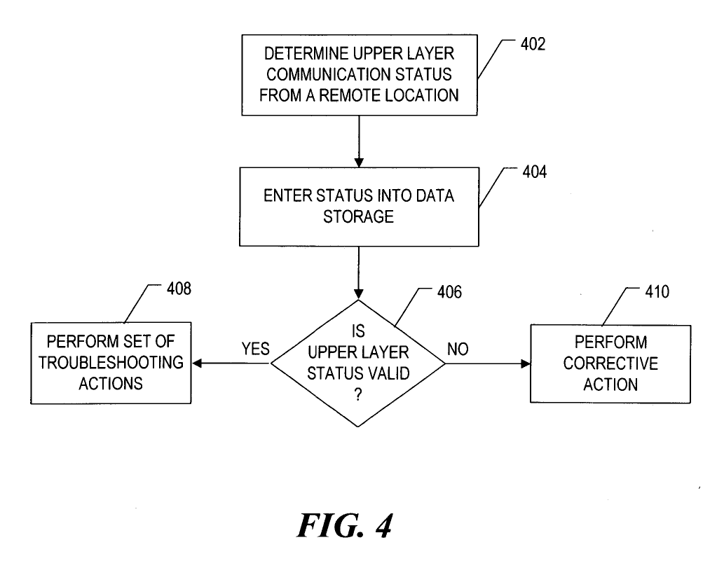

FIG. 4. illustrates a flow diagram for trouble-shooting a DSL connection according to an embodiment of the present invention. An upper-layer status is determined from a remote location, at step 402. For example, an access provider technician can inquire, from a remote location, a status of an upper-layer indicator displayed at a CPE transceiver coupled to an end-user computer. A technician, after receiving a trouble call from an end-user, can ask the end-user the visual status of the upper-layer indicator. Next, the status is entered into data storage, at step 404. For example, a technician can enter the status of the upper-layer indicator into an electronic job ticket that documents the trouble request form the user, such as a DSL subscriber. A determination is made whether the upper-layer status indicates valid or invalid communication, at step 406. A first set of actions is performed if the status indicates valid communication, at step 408. For example, a technician can be dispatched to the end-user location to perform a defined set of trouble shooting actions. Alternatively or additionally, a technician can be assigned a list of activities to be performed at the service provider's location, for example, determining operational status of service provider equipment. A second set of actions is performed if the status indicates invalid communication, at step 410. For example, a service technician receiving the trouble call from the end-user can aid the user in the set up of his DSL transceiver to achieve communication, for example, proper PPPoE authentication.

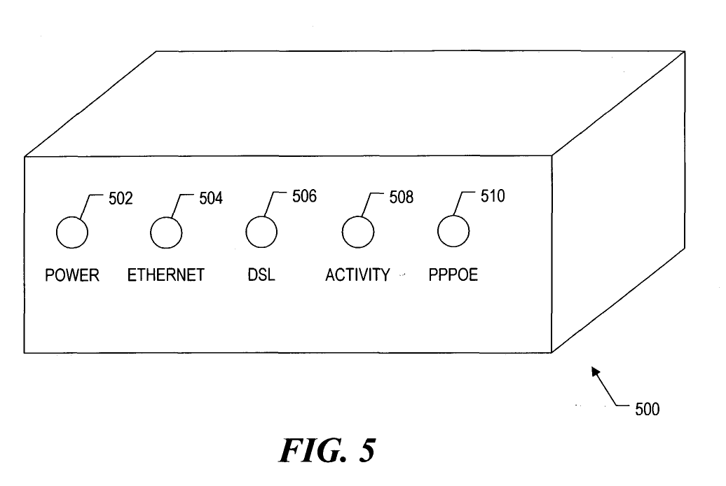

FIG. 5 illustrates a view of a transceiver 500 according to an embodiment of the present invention. As illustrated transceiver 500 includes power LED 502, Ethernet LED 504, DSL LED 506, Activity LED 508, and PPPoE LED 510. PPPoE software runs on router operating system (OS) software and sends requests to the router OS to turn on light the LED light when detecting the condition of PPPoE authentication.

Power LED 502 indicates whether transceiver 500 is connected to a power source. Ethernet LED 504 indicates whether the Ethernet port is connected to the LAN (for example, unlit if not) and the Ethernet traffic flow (for example, when blinking). DSL LED 506 indicates whether DSL is connected and provisioned (for example, DSL enabled when lit) or searching for the DSL signal (for example, when blinking). Activity LED 508 indicates traffic activity on the connection (packets being sent and received). PPPoE LED 510 indicates whether communication such as the PPPoE authentication process, was successful. For example, when the PPPoE authentication process is successful, the light may be lit, may stop blinking, or may change colors.

The transceiver also includes a connection port configured to communicate data signals between an end-user computer and a service provider device, such as a remote DSLAM. An example of deploying a transceiver in a network is where transceiver 102 includes the LED display shown in connection with the transceiver 500.

Accordingly, with the above-described CPE transceiver and provider troubleshooting method, maintenance of a Digital Subscriber Line (DSL) connection is simplified, often saving the time and expense of dispatching an access provider technician to an end-user's premise. Whereas many prior art systems only provide basic visual indicators of connection status, according to the present disclosure, a high level visual indicator is provided that provides visual status, for example, an authentication status, such as Point-to-Point Protocol over Ethernet (PPPoE) authentication status.

The above-disclosed subject matter is to be considered illustrative, and not respective, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
inquiring, from a remote location, a status of an upper-layer communication indicator;
entering the status into data storage;
performing a first set of actions when the status indicates valid upper-layer communication; and
performing a second set of actions when the status indicates invalid upper-layer communication.

2. The method, as recited in claim 1, wherein the inquiring comprises:
a service technician requesting an end-user to provide the status of a light emitting diode (LED) on a Digital Subscriber Loop (DSL) transceiver.

3. The method, as recited in claim 1, wherein the upper-layer communication indicator indicates a Point to Point Protocol Over Ethernet (PPPoE) authentication status.

4. The method, as recited in claim 1, wherein the upper-layer communication indicator indicates a layer 3 or above communication status.

5. The method, as recited in claim 1, wherein entering the status into data storage comprises a service technician entering data into an electronic job ticket.

6. The method, as recited in claim 1, wherein performing the second set of actions comprises a service technician advising an end-user to perform a corrective action to a local configuration.

7. The method, as recited in claim 1, wherein performing the second set of actions comprises a service technician performing a corrective action at the remote location.

8. The method, as recited in claim 1, wherein performing the first set of actions comprises sending a service technician to an end-user location to perform a set of troubleshooting actions.

9. A transceiver comprising:
a connection port configured to communicate data signals from a computer to a service provider device; and
a first status indicator configured to indicate at least a layer 3 or above communication status between the computer and the service provider device.

10. The transceiver, as recited in claim 9, wherein the first status indicator indicates a Point to Point Protocol Over Ethernet (PPPoE) authentication status.

11. The transceiver, as recited in claim 9, wherein the service provider device is a Digital Subscriber Loop Access Multiplexer (DSLAM).

12. The transceiver, as recited in claim 9, further comprising:
a second status indicator configured to indicate a layer 2 connection status between the computer and the service provider device.

13. The transceiver, as recited in claim 12, wherein the second status indicator is a wide area network status indicator.

14. The transceiver, as recited in claim 9, further comprising:
a second status indicator configured to indicate a layer 1 status of the transceiver.

15. The transceiver, as recited in claim 14, wherein the second status indicator is a power status indicator.

16. A method of digital subscriber line service maintenance, the method comprising:
detecting a digital subscriber line (DSL) related troubleshooting event at a remote service terminal that supports an end-user computer having a DSL connection;
inquiring, from the remote service terminal, a status of a visual upper-layer communication indicator associated with a digital subscriber line (DSL) line terminating at the DSL connection of the end-user computer;
entering the status of the visual upper-layer communication indicator into data storage coupled to the service terminal in connection with the DSL related troubleshooting event;
performing a first set of maintenance actions when the status indicates valid upper-layer communication; and
performing a second set of maintenance actions when the status indicates invalid upper-layer communication.

17. The method, as recited in claim 1, wherein the upper-layer communication indicator is a Point to Point Protocol Over Ethernet (PPPoE) authentication status indicator.

18. The method, as recited in claim 1, wherein the upper-layer communication indicator indicates a layer 3 or above communication status, wherein layer 3 is defined by the seven layer OSI model.

19. The method, as recited in claim 1, wherein performing the first set of actions, but not the second set of actions, comprises sending a service technician to the end-user location to perform a set of troubleshooting actions on the end-user computer.
